(19) United States
(12) Patent Application Publication
(10) Pub. No.: US 2015/0116329 A1
(43) Pub. Date: Apr. 30, 2015

(54) MULTI-ATTRIBUTE VISUALIZATION INCLUDING MULTIPLE COORDINATED VIEWS OF NON-OVERLAPPED CELLS

(71) Applicant: Hewlett-Packard Development Company, L.P., Houston, TX (US)

(72) Inventors: Ming C. Hao, Palo Alto, CA (US); Wei-Nchih Lee, Palo Alto, CA (US); Michael Hund, Hauptstrasse (DE); Halldor Janetzko, Baden-Wuerttemberg (DE); Nelson L. Chang, San Jose, CA (US); Daniel Keim, Steisslingen (DE)

(73) Assignee: Hewlett-Packard Development Company, L.P., Houston, TX (US)

(21) Appl. No.: 14/067,328

(22) Filed: Oct. 30, 2013

(51) Int. Cl. G06T 11/20

(52) U.S. Cl. CPC G06T 11/206
USPC 345/440

(57) ABSTRACT

A multi-attribute visualization is generated that includes non-overlapped cells that represent respective items. The cells are placed in the visualization according to geographic locations associated with the items, and the cells being assigned visual indicators to represent a first attribute of the items. The cells are arranged in clusters in the visualization, where a size of a particular one of the clusters indicates a second attribute representing a number of cases associated with a corresponding one of the items. Multiple coordinated views of the cells are presented in the visualization, the multiple views corresponding to respective different time intervals.

### BACKGROUND

With traditional techniques of visualizing attributes (or variables) of large numbers of data records, it can be difficult to understand patterns or other information of the data records. When a relatively large amount of information is to be visualized, the result can be a cluttered visualization where users have difficulty in understanding the visualized information.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments are described with respect to the following figures.

FIG. 1 is a graphical view of an example visualization that includes a multi-view, multi-attribute cell-based representation of data containing a geographic attribute, in accordance with some implementations.

FIG. 2 is a graphical view of another example visualization according to further implementations.

FIG. 3 is a graphical view of drilldown views generated in response to interactive drilldown selection, according to some implementations.

FIG. 4 is a flow diagram of a visualization process, according to some implementations.

FIG. 5 is a block diagram of a system that incorporates some implementations.

### DETAILED DESCRIPTION

Data records can be collected from various sources. For example, a health insurance company may collect data records regarding payments made to healthcare providers, such as hospitals, at various different times. The hospitals may be located at many different geographic locations, such as different locations within the United States or some other geographic region. A location can be represented as a longitude and latitude, or by some other location indicator in other examples. Note that each hospital can also have multiple diagnostic groups (e.g. cardiology group, neurology group, oncology group, etc.). These diagnostic groups are considered to be located at the same location (the location of the respective hospital).

Although reference is made to data records collected for hospitals, it is noted that in other implementations, data records can relate to other types of information. For example, data records can be collected by a financial company, an energy company, and so forth.

More generally, data records can include both spatial information and temporal information, where spatial information relates to geographical locations associated with the data records, and temporal information relates to time associated with the data records. The spatial information of the data records relate to a geographic attribute (or variable) of the data records, while the temporal information relates to a temporal attribute (or variable) of the data records. In the ensuing discussion, the terms “attribute” and “variable” are interchangeably used. The data records can also include other attributes in addition to the spatial and temporal attributes.

To assist analysts in better understanding various information included in collected data records, a multi-view, multi-attribute geo-based visualization is provided. The “multi-view” feature of the visualization refers to the inclusion of multiple views in the visualization, where the multiple views correspond to respective different time intervals. The multi-attribute (or multivariate) feature of the visualization refers to the ability of the visualization to concurrently present information relating to multiple attributes of the data records. Stated differently, multiple attributes are encoded into the visualization, by using different visual features to represent the different attributes. The geo-based feature of the visualization refers to the ability of the visualization to present indications of locations associated with the data records.

The multi-view, multi-attribute geo-based visualization according to some implementations includes cells that represent items about which the data records contain information. The items associated with the data records can be located at various different geographic locations. In the healthcare industry, the items represented by the cells can include hospitals (or other healthcare providers) to which payments are made by a health insurance company. In some implementations, the items can also represent diagnostic groups within hospitals. In other industries, the items represented by the cells can include other objects, such as wells used for extracting hydrocarbons, retail outlets for selling goods or services, electronic devices relating to delivery of electronic services, and so forth. The multiple views are coordinated with each other, in the sense that they represent the same collection of items, but at different time intervals. For example, a first view can be of hospitals in the United States in a first year, while a second view can be of the same hospitals in the United States in a second year. More generally, multiple coordinated views refer to views of items that share a common geographic extent and/or other attribute(s).

In further implementations, the visualization can also have a multi-focus feature, which allows automatic parallel drilldown into a sub-region of each of the multiple views of the visualization in response to a user drilldown selection of a sub-region (“focus region”) in just a single one of the multiple views. The focus region selected by the drilldown selection allows the user to drilldown into a subset of the data records represented by the focus region, so that the user can obtain a more detailed or closer view of the focus region. By automatically drilling down into multiple focus regions in the multiple views in response to just a user selection of a focus region in just a single view, a more convenient mechanism is provided to allow the user to visually compare the focus regions of the multiple views without the user having to individually select the respective focus regions in the multiple views.

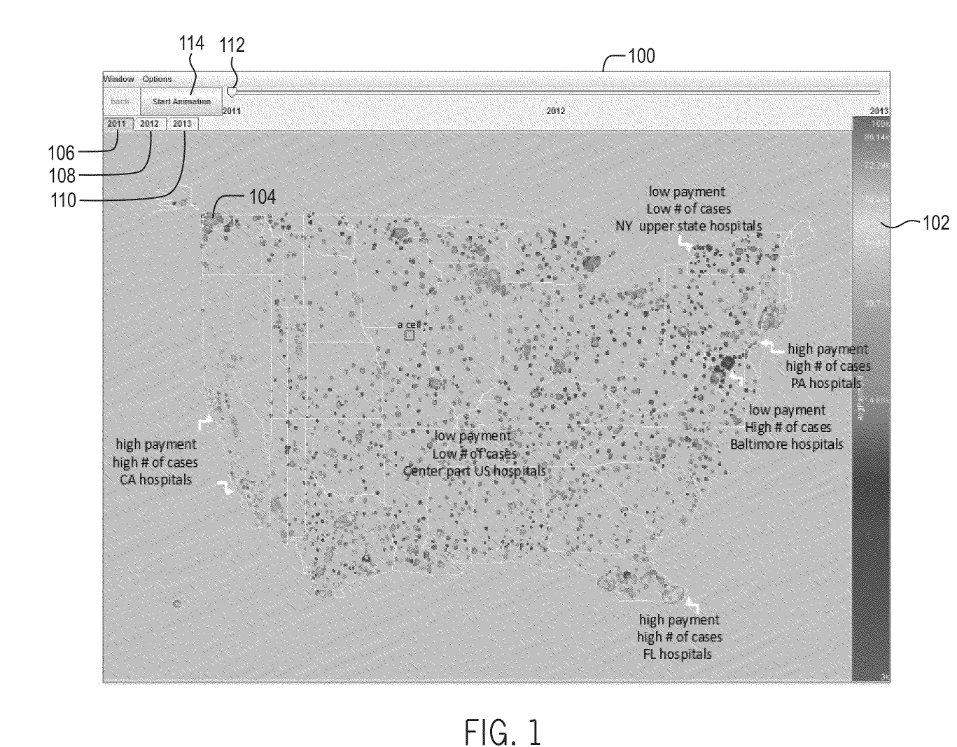

FIG. 1 illustrates an example of multi-view, multi-attribute geo-based visualization 100 that includes cells that represent respective items, and more specifically, hospitals. Although reference is made to cells that represent hospitals (or diagnostic groups in hospitals) in the visualization 100, it is noted that in other examples, the cells of the visualization 100 can represent other types of items. The locations of the cells in the visualization 100 are based on the geographic locations of the respective hospitals represented by the cells. As discussed further below, the cells representing respective items are non-overlapped cells (cells do not overlap each other), to avoid occlusion of the cells.

A cell can refer to a graphical element that is used for representing a respective item. A cell can be in the form of a dot or graphical structure of any other shape. A data record can refer to any discrete unit of data that is received by a system. Each data record can have multiple attributes that represent different aspects of an item. As noted above, the multiple attributes can include a spatial attribute (which indicates a geographic location of an item), a temporal attribute (which indicates a time of an item), and other attributes.

Visual indicators can be assigned to the respective cells, based on one or more specific attributes of the data records. The visual indicators assigned to cells can include different colors, such as colors of a color scale 102 depicted in FIG. 1. In some examples, the color assigned to a cell is based on the amount of payment made to a respective hospital (e.g. from a health insurance company) that is represented by the cell. The amount of payment is indicated by a payment attribute in the data records.

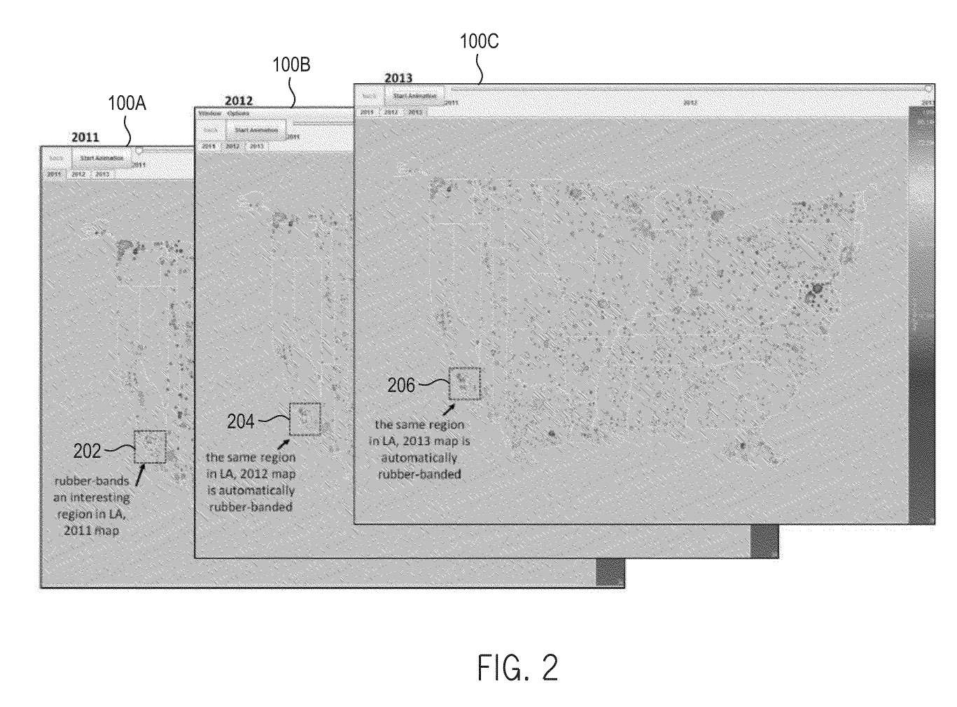

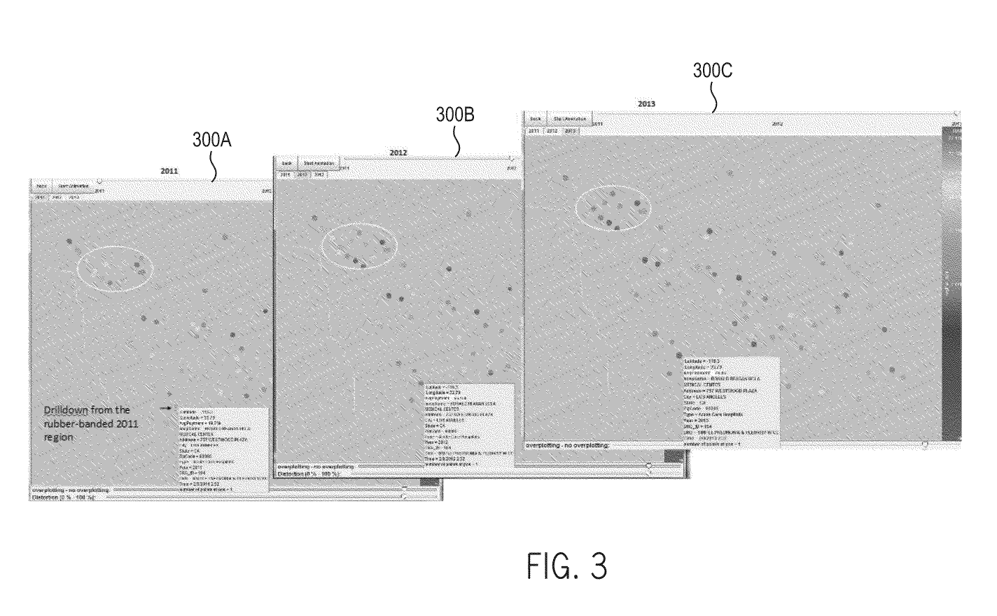

Note that the color scale 102 can represent a relatively large range of values, such as between 3,000 (minimum payment value) and 100,000 (maximum payment value) in the example of FIG. 1. In the example of FIG. 1, the color scale 102 performs a logarithmic mapping which leads to a smaller number of distinct colors for payment values in a higher range of payment values and a larger number of payment values in a lower range of payment values. Alternatively, the mapping of the color scale 102 can also be square root or linear mapping, depending on the distribution of the data. The color scale 102 can be a global color scale that is applied to different views, including those depicted in FIGS. 2 and 3.

A higher payment value is represented by a red color, while a lower payment value is represented by a blue or purple color. Payments of intermediate values are represented by other colors, including yellow and green. In other examples, the color assigned to a cell can be based on another attribute(s) in the data records.

Multiple cells can be used to represent a given individual hospital. The number of cells that are used to represent the given hospital can be based on the number of cases of the given hospital. The number of cases of a given hospital is indicated by a number-of-cases attribute in the data records.

The cases of a hospital can refer to the number of patients treated by the hospital, the number of categories of diseases treated by the hospital, or other types of events associated with the hospital. More generally, the number of cells used to represent a respective item can be based on cases associated with the item, where cases of an item can refer to various distinct events associated with the item. In a different example, where items correspond to retail outlets, the number of cases of each retail outlet can indicate the number of products or the number of services sold by the retail outlet.

As discussed further below, the number of cells used to represent a specific item can be based on a normalized number of cases. Normalization of the number of cases is performed to avoid using a very large number of cells to represent an individual item. For example, a large hospital can treat hundreds of thousands of patients in a year. Using hundreds of thousands of cells to represent this large hospital would likely take up a large part of the visualization 100. Normalization can be performed to map the hundreds of thousands of cases to a normalized number, which can be much smaller. More generally, normalization of numbers of cases involves mapping the numbers of cases to respective specific numbers (which are the normalized numbers). Normalization is discussed further below.

The number of cells that correspond to a given item, where the number of cells is based on the number of cases associated with the given item, are grouped into a cluster of cells and included in the visualization 100. For example, a cluster 104 of cells is indicated in the visualization 100, where this cluster of cells can represent a hospital in the Seattle area, for example. The size of a cluster provides an indication of the number of cases corresponding to the hospital that is in the Seattle area.

The cells used to represent respective hospitals can be placed in the visualization 100 without overlap. If two hospitals are located at the same location, then respective clusters of cells representing the two hospitals can be placed in nearby locations (e.g. adjacent each other) so that the clusters of cells do not overlap. Overlapping of cells can lead to occlusion of the visualized information.

To enhance the clarity of the spatial information depicted by the visualization 100, border lines can be added, such as border lines representing states of the United States. These border lines allow a user to more easily determine where a specific item is located. In other examples, border lines can represent other geographic features.

The cells provided in the example visualization 100 allow a user to visualize at least the following attributes: a spatial attribute relating to locations of the hospitals (or diagnostic groups), a payment attribute relating to amounts of payments made to the hospitals, and a number-of-cases attribute indicating the number of cases associated with each hospital. In the example of FIG. 1, the visualization 100 allows a user to easily determine that (1) some hospitals are associated with high payments and high numbers of cases, (2) some hospitals are associated with high payments and low numbers of cases, (3) some hospitals are associated with low payments and high numbers of cases, and (4) some hospitals are associated with low payments and low numbers of cases.

The visualization 100 can also include multiple coordinated views that correspond to different time intervals. The multiple views are coordinated in the sense that they represent the same hospitals in the same overall geographic region for the different time intervals. In the example visualization 100 of FIG. 1, three tabs 106, 108, and 110 are provided. The tabs 106, 108, and 110 are user selectable, and correspond to different years. In the example of FIG. 1, the different years are 2011, 2012, and 2013. In the example of FIG. 1, the tab 106 is indicated as being selected, such that information relating to the year 2011 is visualized. A user can select tab 108 or tab 110 to select a different year to visualize.

In the example of FIG. 1, a slider 112 is also provided. The slider 112 can be moved in a horizontal direction to change the year that is visualized. In different examples, instead of sliding the slider 112 horizontally, the slider 112 can be moved in a different direction, such as vertically or in another direction.

Also, an animation button 114 can be selected to perform animation of the information that is presented by the visualization 100. If animation is started (such as by a user clicking on the animation button 114 with a user input device), then the visualization 100 successively presents information relating to the different years. For example, when animation is started, the visualization 100 first presents cells representing data records for the year 2011, followed by cells representing data records in the year 2012, and then followed by cells representing data records in the year 2013. During the animation, the slider 112 can be automatically moved to indicate to the user which year is being visualized. In this manner, a user can be able to see the change over time of the visualized information.

In alternative implementations, some of the control elements shown in FIG. 1 can be omitted. For example, the tabs 106, 108, and 110 may be omitted. As another example, the animation button 114 and/or the slider 112 may be omitted.

The visualization 100 allows a user to easily visualize geospatial patterns relating to cost and care at different hospitals. In this way, the user can quickly identify any anomalies. In the visualization 100, hospitals that are associated with high payments but low numbers of cases may be considered anomalous, since the cost per case in such hospitals may be considered unusually high. A health insurance company may take steps to identify reasons for the high cost per case in such hospitals, and can take steps to address the issue.

In addition, if remedial measures or other policies have been implemented, the multiple views of the visualization 100 can allow the user to see effects of such remedial measures or other policies, by visually comparing the visualized information in the different time intervals (e.g. an interval before implementation of the remedial measures or other policies, and an interval after implementation of the remedial measures or other policies).

FIG. 2 shows views 100A, 1008, and 100C corresponding to the visualization 100 of FIG. 1, where the views 100A, 1008, and 100C are for the different years 2011, 2012, and 2013, respectively. The view 100A contains the cells corresponding to the data records for the year 2011, the view 1008 contains cells corresponding to the data records in the 2012, and the view 100C contains the cells corresponding to the data records in the 2013.

The views 100A, 1008, and 100C can be displayed simultaneously, or they can be displayed successively. Also, the views 100A, 1008, and 100C can be displayed in an overlapped fashion, such as shown in FIG. 2.

A further feature provided by some implementations is the ability to perform simultaneous drilldown in the multiple views that correspond to different time intervals, in response to interactive user input that provides a drilldown selection into a focus region. In the example of FIG. 2, it is assumed that a user has selected a focus region 202 in the view 100A. The selection of the focus region 202 can be part of a rubber-band operation, in which a user uses a user input device, such as a mouse device, to define the focus region 202. In other examples, if the display device used to present the visualization is a touchscreen device, then a user can select the focus region 202 using a touch input. The focus region 202 can be selected using any other technique.

The simultaneous drilldown capability of some implementations allows the selection of the focus region 202 (in the view 100A) to be also reflected in the other views 1008 and 100C, without the user having to explicitly select focus regions 204 and 206. In other words, in response to selection of the focus region 202 in the view 100A by the user, the focus regions 204 and 206 in the corresponding views 1008 and 100C are automatically selected.

Note that user selection of a focus region can be performed while animation of the different views 100A, 1008, and 100C is occurring. During the animation, the user can select the focus region in the view that is currently being displayed, and the corresponding focus regions in the other views are then automatically selected.

As shown in FIG. 3, in response to the user selection of the focus region 202 (and the automatic selection of focus regions 204 and 206), drilldown views 300A, 300B, and 300C, for respective years 2011, 2012, and 2013, are presented. The drilldown views 300A, 300B, and 300C contain cells representing hospitals in the focus regions 202, 204, and 206, respectively, selected in FIG. 2. As with the views 100A, 1008, and 100C, the colors assigned to cells are based on payments made to respective hospitals, and the size of a cluster of cells corresponding to each hospital is based on the number of cases associated with the hospital. Noted that the drilldown views are also user interactive, in the sense that a user can interact with each of the drilldown views.

FIG. 3 also shows text boxes (yellow text boxes in the example of FIG. 3) that are displayed, which can be performed in response to a user moving a cursor over a specific cluster of cells. Each text box contains further information regarding the hospital corresponding to the selected cluster of cells.

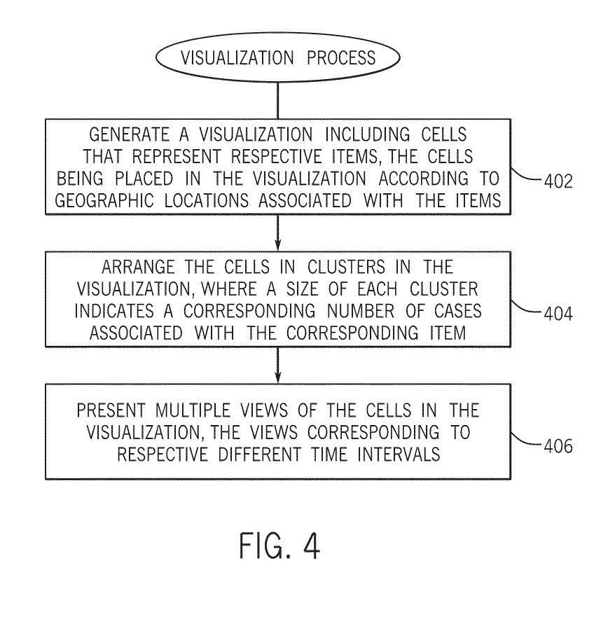

FIG. 4 is a flow diagram of a visualization process according to some implementations. The visualization process generates (at 402) a visualization including non-overlapped cells that represent respective items, the cells being placed in the visualization according to geographic locations associated with the items. The cells are also assigned visual indicators to represent a first attribute of the items.

The visualization process arranges (at 404) the cells in clusters in the visualization, where a size of each cluster indicates a corresponding number of cases associated with the corresponding item.

In addition, the visualization process presents (at 406) multiple coordinated views of the cells in the visualization. The views correspond to respective different time intervals.

As discussed above, to avoid including too many cells that represent respective cases associated with each item represented in the visualization, normalization can be performed to normalize the numbers of cases. Table 1 below indicates the number of cases associated with each of multiple hospitals (hospital_{—}0 to hospital_{—}10).

TABLE 1

| Hospital | # Cases | Normalized # cases |
|---|---|---|
| Hospital_0 | 100 | 40 |
| Hospital_1 | 200 | 50 |
| Hospital_2 | 50 | 31 |
| Hospital_3 | 20 | 19 |
| Hospital_4 | 10 | 10 |
| Hospital_5 | 60 | 34 |
| Hospital_6 | 5 | 1 |
| Hospital_7 | 60 | 34 |
| Hospital_8 | 70 | 36 |
| Hospital_9 | 80 | 37 |
| Hospital_10 | 95 | 40 |

In Table 1, the number of cases for hospital_{—}0 is 100, the number of cases for hospital_{—}1 is 200, and so forth. To avoid including too many cells in a visualization according to some implementations, the number of cases are normalized to be within a specific range. For example, the number of cases can be normalized to a range between 1 and 50, where 50 represents the hospital with the highest number of cases, and 1 represents the hospital with the lowest number of cases. Stated differently, one cell is used for representing a hospital with the lowest number of cases, while 50 cells are used for representing the hospital with the highest number of cases. The values between 1 and 50 are mapped to other numbers of cases accordingly.

Table 1 illustrates an example of such mapping, where the numbers of cases in the second column are mapped to respective normalized numbers of cases in the third column. In the example of Table 1, hospital_{—}1 has the largest number of cases (200), while hospital_{—}6 has the lowest number of cases (5). The number of cases (200) is mapped to the normalized number of cases (50), while the lowest number of cases (5) is mapped to the normalized number of cases (1). The other numbers of cases in Table 1 are mapped to other normalized numbers of cases.

The normalization performed according to some implementations can be a non-linear normalization, such as logarithmic or square root normalization.

If the numbers of cases of respective hospitals are bunched together in a small range, then linear normalization may also produce normalized numbers of cases that are bunched together in a small range. For example, if a first hospital has 300 cases, while the remaining hospitals vary between 10 and 100 cases, then a linear normalization would result in 300 being mapped to 50, while the values between 10 and 100 are mapped to values in a small range around the normalized value 20. As a result, it can be difficult to distinguish the numbers of cases of the hospitals indicated by cell cluster sizes in a visualization.

Non-linear normalization can spread out the values between 10 and 100 across a wider range of normalized values. More generally, non-linear normalization seeks to achieve a more even distribution of normalized numbers of cases.

Pseudocode for an example logarithmic normalization for mapping between numbers of cases and normalized numbers of cases is provided below:

for each hospital h {

h.normalized_#cases :=
Math.floor(
(log(#cases_from_h)−log(min))/(log(max)−log(min))*(maxPixelCell−1)+1);

}

In the foregoing, the normalized number of cases computed for a hospital h is represented by normalized_#cases. The parameter #cases_from_h represents the actual number of cases of the hospital. The parameter min represents the minimum actual number of cases of all the hospitals considered, while the parameter max represents the maximum actual number of cases of all the hospitals considered. The parameter maxPixelCell represents the maximum normalized value (e.g. 50 in the foregoing examples).

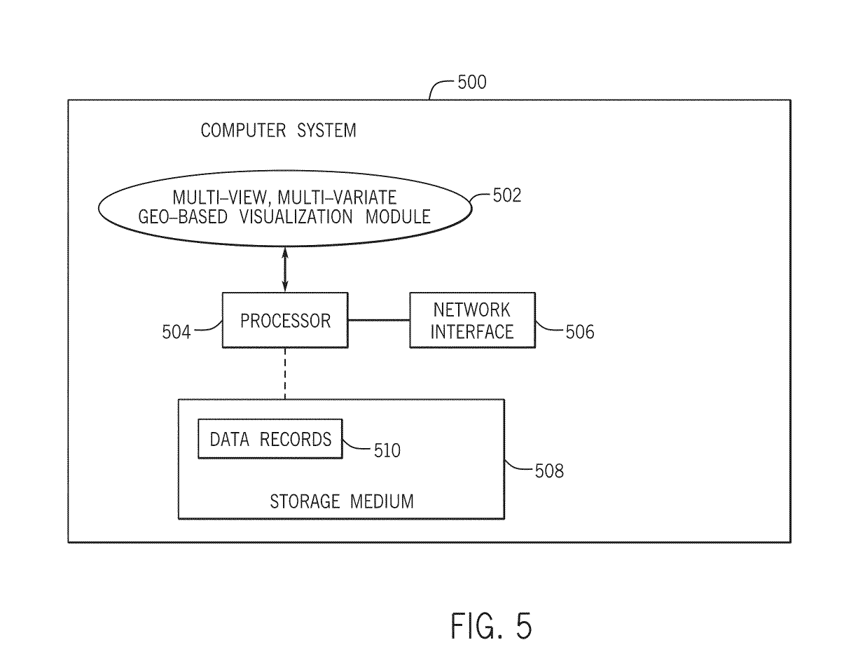

FIG. 5 is a block diagram of a computer system 500 that includes a multi-view, multi-attribute geo-based visualization module 502 that is executable on one or multiple processors 504. The multi-view, multi-attribute geo-based visualization module 502 is able to generate visualizations according to some implementations, such as discussed above.

The processor(s) 504 can be coupled to a network interface 506, which allows the computer system 500 to communicate over a data network. The processor(s) 504 can also be coupled to a storage medium (or storage media) 508, which can store data records 510. A processor can include a microprocessor, microcontroller, processor module or subsystem, programmable integrated circuit, programmable gate array, or another control or computing device.

The storage medium (or storage media) can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
generating, by a system including a processor, a multi-attribute visualization including non-overlapped cells that represent respective items, the cells being placed in the visualization according to geographic locations associated with the items, the cells being assigned visual indicators to represent a first attribute of the items;
arranging, by the system, the cells in clusters in the visualization, wherein a size of a particular one of the clusters indicates a second attribute representing a number of cases associated with a corresponding one of the items; and
presenting, by the system, multiple coordinated views of the cells in the visualization, the multiple views corresponding to respective different time intervals.

2. The method of claim 1, further comprising:
receiving, by the system, a request to focus into a sub-region of the visualization, wherein the request to focus is based on user selection in one of the plurality of views; and
in response to the request, performing parallel drilldown by presenting a second visualization that drills down into the focused sub-region that contains cells in each of the plurality of views.

3. The method of claim 1, further comprising:
receiving, by the system, user selection of a user-selectable element to activate animation; and
in response to the user selection of the user-selectable element, animating the visualization by displaying the multiple views in sequence.

4. The method of claim 1, further comprising:
normalizing numbers of cases associated with the respective items, to produce normalized numbers of cases; and
wherein a number of cells in each of the clusters is based on the respective normalized number of cases.

5. The method of claim 4, wherein the normalizing is a non-linear normalization.

6. The method of claim 1, further comprising:
receiving, by the system, user selection of one of the plurality of views to present.

7. The method of claim 6, wherein receiving the user selection comprises receiving user selection of a user-selectable element presented in the visualization.

8. The method of claim 6, wherein receiving the user selection comprises receiving activation of a slider that is slideable along a direction to change to different ones of the plurality of views.

9. The method of claim 1, further comprising:
assigning visual indicators to the cells in the visualization according to corresponding values of the first attribute of the items.

10. The method of claim 6, wherein assigning the visual indicators comprise assigning different colors according to the corresponding values of the first attribute of the items.

11. A system comprising:
at least one processor to:
cause display of a multi-attribute, multi-view visualization including non-overlapped cells that represent respective items, the cells being placed in the visualization according to geographic locations associated with the items, the cells being assigned visual indicators to represent a first attribute of the items, and the visualization including a plurality of coordinated views of the cells that correspond to respective different time intervals;
arrange the cells in clusters in the visualization, wherein a size of a particular one of the clusters indicates a second attribute representing a number of cases associated with a corresponding one of the items.

12. The system of claim 11, wherein the visual indicators include different colors assigned to the cells based on values of the first attribute.

13. The system of claim 12, wherein the at least one processor is to further:
include a color scale in the visualization, the color scale including different colors mapped to respective different value of the first attribute.

14. The system of claim 13, wherein the at least one processor is to further:
present a drilldown visualization in response to selection of a focus in one of the views; and
include the color scale in the drilldown visualization.

15. The system of claim 11, wherein the at least one processor is to further animate the visualization to cause animated display of the views in sequence.

16. The system of claim 15, wherein the at least one processor is to further:
receive a drilldown selection of a focus region in a presently displayed one of the views; and
in response to the drilldown selection, automatically select focus regions in others of the views.

17. The system of claim 11, wherein the at least one processor is to further:
normalize numbers of cases associated with the respective items, to produce normalized numbers of cases; and
wherein a number of cells in each of the clusters is based on the respective normalized number of cases.

18. An article comprising at least one non-transitory machine-readable storage medium storing instructions that upon execution cause a system to:
receive data records corresponding to items, each of the data records including a plurality of attributes;
generate a multi-attribute visualization including non-overlapped cells that represent the respective items, the cells being placed in the visualization according to geographic locations associated with the items, the cells being assigned visual indicators to represent a first of the attributes;
arrange the cells in clusters in the visualization, wherein a size of a particular one of the clusters indicates a second of the attributes representing a number of cases associated with a corresponding one of the items;
present multiple coordinated views of the cells in the visualization, the multiple views corresponding to respective different time intervals; and
generate a drilldown visualization in response to a drilldown selection of a focus region in one of the multiple views, the drilldown visualization including multiple drilldown views produced in parallel in response to the drilldown selection, and the drilldown visualization being user interactive.

19. The article of claim 18, wherein the instructions upon execution cause the system to further animate the multi-attribute visualization by successively displaying the multiple views.
